(19) United States
(12) Patent Application Publication
(10) Pub. No.: US 2012/0172171 A1
(43) Pub. Date: Jul. 5, 2012

(54) MULTISTAGE TRANSMISSION

(76) Inventor: Donghwan Byun, Seoul (KR)

(21) Appl. No.: 13/322,560

(22) PCT Filed: May 26, 2010
(86) PCT No.: PCT/KR2010/003344

§ 371 Date: Feb. 21, 2012

(30) Foreign Application Priority Data
May 26, 2009 (KR) 10-2009-0046150
Jul. 14, 2009 (KR) 10-2009-0063882

(51) Int. Cl. F16H 3/62; F16H 3/46

(52) U.S. Cl. 475/275; 475/271

(57) ABSTRACT

The present invention relates to a multistage transmission, comprising: a center shaft arranged in a frame such that the center shaft does not rotate; an input member arranged coaxially to the center shaft such that the input member is rotatable; a hub arranged coaxially to the center shaft such that the hub is rotatable; an epicyclic gear set which is coupled to the input member and mounted on the hub, and which is arranged coaxially to the center shaft such that the epicyclic gear set is rotatable, and which has at least two pairs of epicyclic gears, wherein each of the epicyclic gears has a sun gear, a ring gear, a satellite carrier and a pinion; an axial clutch which is involved in the operation of the sun gear which is selectively coupled to or separated from at least one of the peripheral members; a clutch assembly in which at least one of the clutches in a rotating direction are arranged in correspondence with the respective sun gears, wherein said clutches in the rotating direction are involved in the operation of the sun gear which is selectively coupled to or separated from the center shaft; and a transmission shaft which has a hollow portion and a plurality of radial through-holes, and which covers the center shaft and rotates to select a rotating direction, and which is involved in the operation of the clutch assembly. The multistage transmission of the present invention provides two or more gear ratios between the input member and the hub in accordance with the rotating direction of the transmission shaft.

### TECHNICAL FIELD

The present invention relates to a epicyclic gear-type multistage transmission.

### BACKGROUND ART

Many exemplary embodiments of a multistage transmission which is used in daily life and industrial field are known. For example, a plurality of sprockets is overlapped to be installed in a rear wheel hub and crank to be coupled by a chain and a transmission stage is selected by a derailleur. Such transmission may realize 27 gear ratios. However, such gear ratio may overlap or transmission from one stage to another stage is not performed at a consistent ratio.

As another form of transmission, a epicyclic gear-type hub transmission which has a epicyclic gear installed in a hub and controls a rotation of a sun gear to couple or decouple the sub gear and a center shaft is provided.

There is a transmission which has 8 gear ratios and forms a ratchet pawl in a sun gear and forms a coupling groove in a center shaft to be coupled with the pawl to thereby control the operation of the pawl coupled to or separated from the coupling groove. This type of transmission has complicated and numerous transmission shaft and peripheral parts, which is difficult to manufacture and has inconsistent acceleration ratio among transmission stages.

There is a transmission which has 14 gear ratios and mounts a ratchet pawl in an external circumference of a center shaft, mounts a transmission shaft having a cam surface in a hollow portion of the center shaft, forms a coupling groove in an internal circumference of a sun gear to be coupled with the pawl so that the pawl stands or lies down along the cam surface to be coupled to or separated from the sun gear. As the transmission shaft is inserted into the center shaft, a radius of the center shaft cannot be smaller, increasing the size the transmission. Nevertheless, an external diameter of the transmission shaft is small and the number of the transmission stages is limited. As the transmission shaft rotates twice, the number of the transmission stage increases.

### DISCLOSURE

### Technical Problem

The present invention has been made to solve the problems and it is an object of the present invention to provide a multistage transmission which has a small structure and a light weight and efficiently includes various transmission stages.

It is another object of the present invention to provide a multistage transmission which enables a quick transmission without cutting off or bypassing power for such transmission even while driving or suspension and has each transmission stage converted into a next stage at a same gear ratio.

### Technical Solution

In order to achieve the object of the present invention, a multistage transmission comprises a center shaft arranged in a frame such that the center shaft does not rotate; an input member arranged coaxially to the center shaft such that the input member is rotatable; a epicyclic gear set which is coupled to the input member and which is arranged coaxially to the center shaft such that the epicyclic gear set is rotatable, and which has at least two pairs of epicyclic gears, wherein each of the epicyclic gears has a sun gear, a ring gear, a satellite carrier and a pinion; an axial clutch which is involved in the operation of the sun gear which is selectively coupled to or separated from at least one of the peripheral members; a clutch assembly in which at least one of the clutches in a rotating direction are arranged in correspondence with the respective sun gears, wherein said clutches in the rotating direction are involved in the operation of the sun gear which is selectively coupled to or separated from the center shaft; a transmission shaft which has a hollow portion and a plurality of radial through-holes, and which covers the center shaft and rotates to select a rotating direction, and which is involved in the operation of the clutch assembly; and a hub arranged coaxially to the center shaft such that the hub is rotatable, and the multistage transmission providing two or more gear ratios between the input member and an output member of the multistage transmission in accordance with the rotating direction of the transmission shaft.

The multistage transmission according to the present invention relates to a transmission control part of an epicyclic gear transmission, wherein a transmission shaft supports the center shaft for rotation and controls the clutch operating in an axial direction. The peripheral member comprises a ring gear or a pinion within the same pinion or the pinion a sun gear with adjacent epicyclic gear.

### Advantageous Effect

As described above, a transmission according to the present invention provides various transmission stages effectively, and has a small structure and a light weight. The transmission according to the present invention ensures a quick transmission without cutting off or bypassing power for such transmission even while driving or suspension and has each stage converted into a next stage at a same gear ratio.

### BRIEF DESCRIPTION OF DRAWINGS

FIG. 1 is a sectional view of a hub transmission which may be installed in a rear wheel of a bicycle as an example of a multistage transmission according to the present invention.

FIG. 2 illustrates the transmission in FIG. 1.

FIG. 3 illustrates a transmission which may be installed in the vicinity of a bicycle crank as an example of the multistage transmission according to the present invention.

FIG. 4 is an exploded perspective view of the transmission in FIG. 1.

FIG. 5 is an exploded perspective view of a pair of epicyclic gears in an input side.

FIG. 6 is an exploded perspective view of a pair of epicyclic gears in an output side in FIG. 4.

FIG. 7 is an exploded perspective view of a center shaft and a transmission shaft in FIG. 4.

FIG. 8 is an exploded perspective view of a two-stage epicyclic gear in an output side in FIG. 4.

FIG. 9 illustrates a fifth epicyclic gear in FIG. 1.

FIG. 10 illustrates an operation of a pawl of the transmission in FIG. 1.

### BEST MODE

Terms and words used in this application and the claims herein shall not be interpreted as only customary or dictionary meanings. Instead, such terms and words shall be interpreted as the meaning and concept consistent with the technical spirit of the present invention in accordance with the principle that the inventor may properly define the meaning of terms to explain his/her invention in a best manner.

Accordingly, exemplary embodiments stated in this application and the configurations shown in drawings are preferably exemplary embodiments according to the present invention, but do not represent all of the technical spirit of the present invention. As a result, it shall be understood that there may be various equivalents and modifications which may replace the exemplary embodiments of the present invention at the time of filing this application.

The term “axial direction” is used to refer to the direction or location along the shaft in parallel with a center shaft of the transmission. The terms “radius” and “radial direction” are used to refer to the direction or location extending vertically to the center shaft of the transmission. For clarity and simplicity, like elements with like reference numerals (e.g., pawl spring 64a and pawl spring 64b) will be named as single reference numerals (e.g., a control piston 582).

24 Hereinafter, a multistage transmission according to exemplary embodiments of the present invention will be described in detail with reference to accompanying drawings. Even though a transmission according to a present exemplary embodiment is employed in a bicycle, it may be employed in any device which converts an input speed for output.

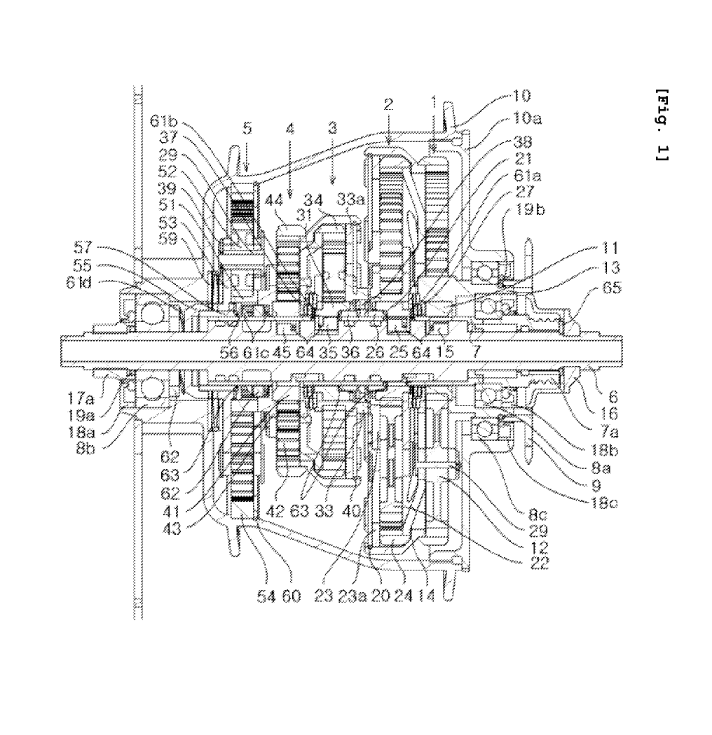

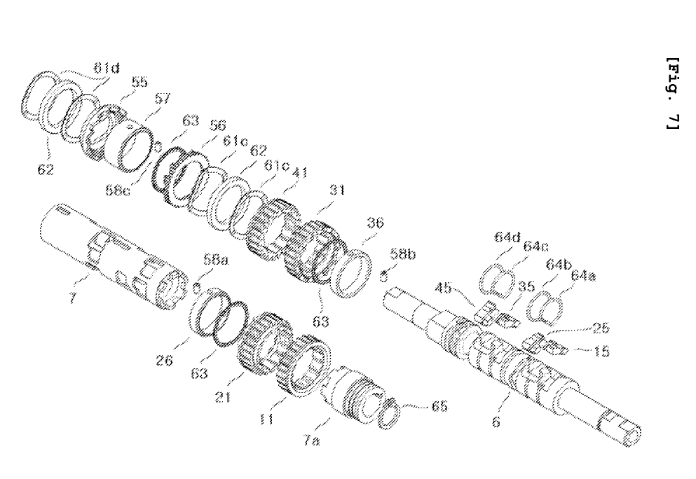

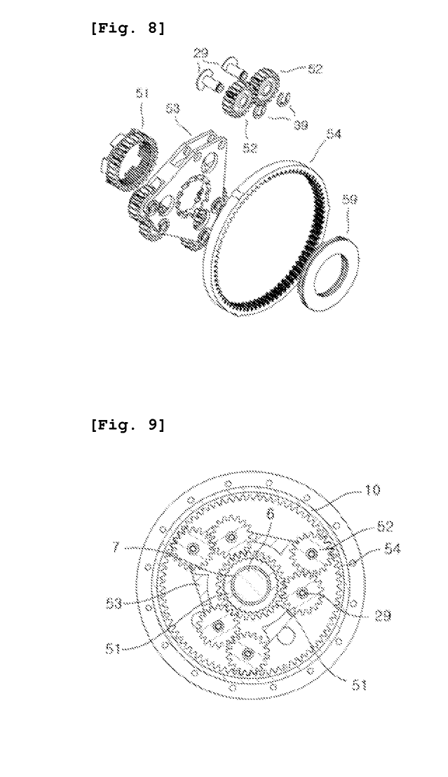

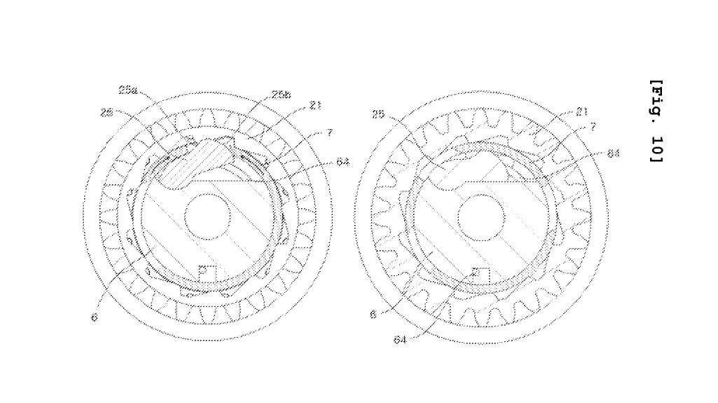

Referring to FIGS. 1 and 7, a center shaft 6 of a multistage transmission according to the present invention includes a shaft which has a step 6e and a hollow through hole 6f in opposite section to be installed in a frame (not shown) such that the center shaft 6 does not rotate. Two direct-connection clutch guide groove 6a are formed in a central surface of the center shaft 6, and a concave cam surface 6b is formed in an axial direction in a lateral surface of each groove toward a counterpart groove for a direct-connection clutch. The concave groove of the cam surface 6b is programmed in advance to operate direct-connection clutches 21 and 31, and is set at a proper interval upon determination of a transmission stage. The concave groove is programmed at an interval of 40° for 9 speed transmission.

A pair of concave pawl grooves 6c are formed in an axial direction at a predetermined interval to accommodate therein ratchet pawls 15, 25, 35 and 45 in opposite surfaces of the center shaft 6. A pawl spring groove 6g is formed in each of the pawl grooves 6c to accommodate therein pawl springs 64a, 64b, 64c and 64d to apply an elastic force so that the pawls 15, 25, 35 and 45 may rotate and stand.

Two-rotation clutch guiding groove 6d is formed as in FIG. 7 with respect to two-stage clutch 5. A first rotation 6d1 is performed from zero degree to 320° by maintaining a position in an axial direction, and moves in the axial direction from 320° to 360° while a second rotation 6d2 maintains an original position in an axial direction from 360° to 680°.

A transmission shaft 7 is a tubular member which surrounds the center shaft 6 and rotates. The transmission shaft 7 include a transmission shaft 7 including a plurality of pawl operation holes 7b engaging in the operation of the ratchet pawls 15, 25, 35 and 45 in a main surface and a guide groove guiding the 2-stage clutch guiding pin 58c and the direct-connection clutch guiding pin 58b in a rotation direction, and a transmission shaft 7 including a groove 7f fixing a transmission wire connected to control a rotation of the transmission shaft from the outside and a wire 7e to wind the transmission wire. The transmission shafts 7 and 7a are coupled by an uneven projection not to rate relatively. The transmission shaft 7 is fixed to the center shaft 6 by a lateral wall 6h of the center shaft 6 and a snap ring 65 fixed to the center shaft 6 not to be moved in an axial direction, and has a step formed to support a bearing 8a in an axial direction.

The pawl operation hole 8b of the transmission shaft 7 is a through hole in a radial direction and provides a space to permit the pawl to stand. The pawl operation hole 8b is programmed in advance at a proper interval to operate the pawls 15, 25, 35 and 45 once the transmission stage is determined. Here, the pawl operation hole 8b is programmed at an interval of 40° to enable a 9-stage transmission. Guide pin guiding grooves 7c and 7d are through holes elongated in an axial direction.

A lateral wall 7e of the pawl operation hole 7b in a rotation direction is involved in the operation that the pawls 15, 25, 35 and 45 are inserted into the respective pawl grooves 6c, and is inclined to efficiently insert the pawls 15, 25, 35 and 45 into the grooves 6c in cooperation with the pawl cams 25a and 25b not to receive a rotational resistance from the pawls 15, 25, 35 and 45 when the transmission shaft 7 rotates and controls the pawls 15, 25, 35 and 45.

The pawls 15, 25, 35 and 45 are rotational members which stand toward sun gears 11, 21, 31 and 41 or inserted into the pawl grooves 6c of the center shaft 6 by a control of the transmission shaft 7 with the supporting point in the center shaft 6 between the center shaft 6 and the transmission shaft 7. Projections are formed in opposite sides of the pawls to support the pawls and to prevent the pawls from being separated from their positions. Pawl guiding cams 25a and 25b are formed in one side of the pawls 15, 25, 35 and 45 which guides the pawls 15, 25, 35 and 45 to be inserted into the pawl grooves 6c by a rotation of the transmission shaft 7 guide the pawls 15, 25, 35 and 45 to be efficiently inserted into the pawl grooves 6c by a rotation of the transmission shaft 7 clockwise or counterclockwise. The pawls 15, 25, 35 and 45 receives the force from springs 64a, 64b, 64c and 64d surrounding the pawls 15, 25, 35 and 45 to stand, and stand toward the sun gears 11, 21, 31 and 41 when the through hole 7b of the transmission shaft 6 allows the standing of the pawls 15, 25, 35 and 45.

The pawls 15, 25, 35 and 45 are installed such that they stand in opposite directions within the same pair of epicyclic gears to prevent a rotation of the sun gears 11, 21, 31 and 41 and to ensure a change in speed. In an exemplary embodiment in which the power is transmitted by a clockwise rotation, an input pawl 15 of a pair of epicyclic gears 1 and 2 in an input side is arranged to prevent the clockwise rotation of the sun gear 11 while the pawl 25 in an output side is arranged to prevent a counterclockwise rotation of the sun gear 21. In a pair of epicyclic gears 3 and 4 in an output side, an input pawl 35 is arranged to prevent a clockwise direction of the sun gear 31 while an output pawl 45 is arranged to prevent a counterclockwise rotation of the sun gear 41.

Direct-connection clutch guide rings 26 and 36 are installed to surround the transmission shaft 7, support the sun gears 21 and 31 pressing the guide rings 26 and 36 in an axial direction and are coupled to the direct-connection clutch guide pins 58a and 58b to move in an axial direction along the guide pines 58a and 58b. A bearing 63 is installed between the direct-connection clutch guide rings 26 and 36 and the sun gears 21 and 31 to reduce friction caused by the rotation of the sun gears 21 and 31. The direct-connection guide pins 58a and 58b are coupled to the direct-connection clutch guide rings 26 and 36, and rotate together with the transmission shaft 7 through the through hole 7c elongated in an axial direction of the transmission shaft 7 and along the cam surface 6b of the direct-connection clutch guide groove formed in the center shaft 6 to move in an axial direction.

The two-stage clutch guide ring 57 is installed to surround the transmission shaft 7, to be coupled to the two-stage clutch guide pin 58c and to move in an axial direction along the guide pin 58c. The two-stage clutch guide pin 58c is coupled to the two-stage clutch guide ring 57 and rotates together with the transmission shaft 7 through the two-stage clutch guide pin guide groove 7d as a through hole elongated in an axial direction of the transmission shaft 7 and along the cam surface of the two-stage clutch guide groove 6d formed in the center shaft 6, maintains its original position in an axial direction by the first rotation 6d1 of the transmission shaft 7 and moves in an axial direction by the second rotation 6d2.

A two-stage transmission clutch 55 and a two-stage direct-connection clutch 56 are arranged in opposite sides of the two-stage clutch guide ring 57. The two-stage transmission clutch 55 contacts the two-stage clutch guide ring 57 by being pressed by a spring 61d and fixed to the center shaft 6 not to rotate and moves in an axial direction along the two-stage clutch guide ring 57, wherein an inclined step is formed in a lateral side toward the two-stage direct-connection clutch 56 to prevent a clockwise direction. The two-stage direct-connection clutch 56 contacts the two-stage clutch guide ring 57 by being pressed by a spring 61c, is coupled to the two-stage clutch sun gear 51 not to rotate relatively, and moves in an axial direction along the two-stage clutch guide ring 57, wherein an inclined step is formed in a lateral side toward the two-stage transmission clutch 55 to prevent a counterclockwise rotation.

The sun gears 11 and 41 have an inclined groove formed in an internal circumference thereof for the ratchet pawls 15 and 45, and a lateral wall formed in a lateral side thereof. The lateral wall is disposed between carriers 13 and 43 and a pinion 1242 so that the sun gears 11 and 41 do not move in an axial direction. The respective sun gears 11 and 41 are arranged in an axial direction to be coupled with the pawls 15 and 45, respectively. The sun gear 11 has an inclination arranged to prevent a clockwise rotation while the sun gear 41 has an inclination arranged to prevent a counterclockwise rotation.

The sun gears 21 and 31 have an inclined groove formed in an internal circumference for the ratchet pawls 25 and 35, and an inclined step is formed in one side of the sun gears 21 and 31 to prevent a rotation in one direction. The respective sun gears 21 and 31 are arranged in an axial direction to be coupled with the pawls 25 and 35. The sun gear 21 has an inclination arranged to prevent a counterclockwise rotation, and a lateral inclined step protrudes toward the sun gear 31 to prevent a counterclockwise rotation. The sun gear 31 has an inclination arranged to prevent a counterclockwise rotation, and a lateral inclined step protrudes toward the sun gear 21 to prevent a clockwise rotation.

The sun gears 21 and 31 are pressed by the springs 51a and 61b and surround the direct-connection clutch guide rings 26 and 36, and move in an axial direction by the movement of the direct-connection clutch guide rings 26 and 36 in an axial direction to thereby be coupled to or separated from the direct-connection clutch ring 38.

The direct-connection clutch ring 38 is coupled to the carrier 33 of the epicyclic gear between the two sun gears 21 and 31 not to rotate, and an inclined step in an axial direction is formed in opposite direction to prevent the rotation of the sun gears 21 and 31 by being coupled to a lateral projection of the sun gears 21 and 31. In the direct-connection clutch ring 38, an inclined step in an axial direction is formed in a side contacting the sun gear 21 to prevent a counterclockwise rotation of the sun gear 21, and an inclined step in an axial direction is formed in another side contacting the sun gear 31 to prevent a clockwise rotation of the sun gear 31.

If the direct-connection clutch guide cam surface 6b is flat and the direct-connection clutch is separated, the direct-connection cutch guide ring 26 presses the sun gear 21 and guides the sun gear 21 to a location not to be coupled to the direct-connection clutch ring 38. In a location in which the direct-connection clutch guide cam surface 7b is concave, the direct-connection clutch guide ring 26 progresses together with the sun gear 21 by the pressure of the spring 61a. As a result, the direct-connection clutch ring 38 is coupled to the sun gear 21.

If the direct-connection clutch guide cam surface 6b is flat and the direct-connection clutch is separated, the direct-connection cutch guide ring 26 presses the sun gear 21 and guides the sun gear 21 to a location not to be coupled to the direct-connection clutch ring 38. In a location in which the direct-connection clutch guide cam surface 7b is concave, the direct-connection clutch guide ring 26 progresses together with the sun gear 21 by the pressure of the spring 61a. As a result, the direct-connection clutch ring 38 is coupled to the sun gear 21.

The epicyclic gear set may include 3, 6, 9, 12 or 18 stages based on a pair of epicyclic gears. As an example, if a pair of epicyclic gears 1-2 in an input side, a pair of epicyclic gears 3-4 in an output side and two-stage epicyclic gear 5 are coupled in series, an epicyclic gear transmission which provides 18 stage gears may be provided.

The pairs of epicyclic gears 1-2 and 3-4 include two epicyclic gears 1 and 2 or 3 and 4, wherein one epicyclic gear operates in an input side of the pair of epicyclic gears and the other epicyclic gear operate in an output side of the pair of epicyclic gears. The sun gear of the pair of epicyclic gears is used to control change in speed, and a carrier integrally coupled to the ring gear operates in an input side and an output side of the pair of epicyclic gears.

An input carrier 13 of the pair of epicyclic gears 1-2 in an input side in FIG. 5 has a through hole having a step to support and accommodate the sun gear 11, and three grooves to accommodate three pinions 12 and three through holes in an axial direction to support a pinion shaft 29. A screw is formed in an external circumference protruding from one side of the carrier 13 to be coupled with a sprocket, and a cylindrical member having a through hole to accommodate a bearing is formed in an internal circumference. In an opposite side, a groove is formed to accommodate a thrust bearing 27.

The pinion 12 is installed to rotate together with the carrier 13 by being fixed to the carrier 13 by the pinion shaft 29 fixed to three through holes of the carrier by the snap ring 39. The sun gear 11 rotates as the lateral wall of the sun gear 11 is supported by a supporting projection of the carrier 13 and being engaged with the pinion 12 and fixed to the carrier 13 in an axial direction.

An output carrier 23 of the pair of epicyclic gears in an input side has a through hole to accommodate the sun gear 21, and three grooves to accommodate three pinions 22 and three through holes in an axial direction to support the pinion shaft 29, and a projection is formed in one side to be coupled with the input carrier 33 of the pair of epicyclic gears 3-4 in an output side. In an opposite side, a groove is formed to accommodate the thrust bearing 27.

The pinion 22 is installed to rotate together with the carrier 23 by being fixed to the carrier 23 by the pinion shaft 29 fixed to three through holes of the carrier 23 by the snap ring 39. The sun gear 21 rotates as the lateral wall of the sun gear 21 is supported in an axial direction by the spring 61a supported by the thrust bearing 27 and being engaged with the pinion 22 for rotation.

The ring gear 24 in an output side extends in a radial direction and is coupled to the input carrier 13 not to rotate. The ring gear 14 in an input side extends in an axial direction, surrounds the ring gear 24 in an output side to be coupled with an output carrier adaptor 23a extending from the output carrier 23 by an uneven projection not to rotate.

The thrust bearing 27 is installed between the input carrier 13 and the output carrier 23, maintains the gap therebetween and supports a spring pressing the sun gear 21.

An input carrier 33 of the pair of epicyclic gears 3-4 in an output side coupled to the pair of epicyclic gears 1-2 in an input side not to rotate has a through hole to accommodate the sun gear 31, three grooves to accommodate three pinions 32 and three through holes in an axial direction to support the pinion shaft 29, and a projection is formed in one side to be coupled to an output carrier 23 of the pair of epicyclic gears 1-2 in an input side and the direct-connection clutch ring 38. In an opposite side, a groove is formed to accommodate the thrust bearing 37.

The pinion 32 is installed to rotate together with the carrier 33 by being fixed to the carrier 33 by the pinion shaft 29 fixed to three through holes of the carrier 33 by the snap ring 39. The sun gear 31 rotates as the lateral wall of the sun gear 31 is supported in an axial direction by the spring 61b supported by the thrust bearing 37 and being engaged with the pinion 32 for rotation.

An output carrier 43 of the pair of epicyclic gears 3-4 in an output side has a through hole having a step to support and accommodate the sun gear 41, three grooves to accommodate three pinions 42 and three through holes in an axial direction to support the pinion shaft 29, and a projection is formed in one side of the carrier 43 to be coupled to an two-stage clutch sun gear 51. In an opposite side, a groove is formed to accommodate the thrust bearing 37.

The pinion 42 is installed to rotate together with the carrier 43 by being fixed to the carrier 43 by the pinion shaft 29 fixed to three through holes of the carrier 43 by the snap ring 39. The sun gear 41 rotates as the lateral wall of the sun gear 41 is supported by a supporting projection of the carrier 43 and being engaged with the pinion 42 and fixed to the carrier 43 in an axial direction for rotation.

The ring gear 34 in an input side extends in a radial direction and is coupled to the output carrier 43 not to rotate. The ring gear 44 in an output side extends in an axial direction, surrounds the ring gear 34 in an input side to be coupled with an input carrier adaptor 33a extending from the input carrier 23 by an uneven projection not to rotate.

The thrust bearing 37 is installed between the input carrier 33 and the output carrier 43, maintains the gap therebetween and supports a spring pressing the sun gear 31.

The two-stage transmission epicyclic gear 5 may use one of the sun gear 51 and the carrier 53 as a fixing element; use the sun gar, the carrier and the ring gear as an input element; and the ring gear and the carrier as an output element. If the sun gear is used as the fixing element, one of deceleration and direct connection and acceleration and direct connection. If the carrier is used as the fixing element, deceleration and direct-connection transmission is possible. In the case of deceleration, a double pinion is used.

Referring to FIG. 2, the carrier 53 is used as the fixing element to constitute deceleration and direct-connection transmission, and the carrier 53 operates with opposite clutches. The carrier 53 surrounds the two-stage clutch guide ring 57 between the two-stage transmission clutch 55 and the two-stage direct-connection clutch 56, includes a groove to accommodate the pinion 52, and 6 through holes in an axial direction to fix the pinion 52 to the carrier 53. An inclined projection is formed in a lateral wall of the carrier 53 facing a housing 10 to be coupled with the two-stage transmission clutch 55 and prevent a counterclockwise rotation of the carrier 53, and an inclined projection is formed in a lateral wall facing the pair of epicyclic gears 3-4 in an output side to be coupled with the two-stage direct-connection clutch 56 and rotate with the clockwise rotation of the two-stage direct-connection clutch 56. The location of the carrier 53 in an axial direction is fixed and maintained by the thrust bearing 59 supported by the housing 10 and the two-stage clutch sun gear 51.

The pinion 52 is fixed to the carrier 53 by the pinion shaft 29, and rotates together with the carrier by being engaged with the two-stage clutch sun gear 51 and the ring gear 54.

The two-stage clutch sun gear 51 is coupled to the output carrier 43 of the pair of epicyclic gears 3-4 in an output side not to rotate relatively, supports the lateral wall of the carrier 53, surrounds and is coupled to the two-stage direct-connection clutch 56 to rotate.

If the two-stage clutch guide ring 57 moves in an axial direction by a rotation of the transmission shaft 7, the two-stage transmission clutch 55 and the two-stage direct-connection clutch 56 move in an axial direction and are coupled to the inclined step of the carrier 53. If the two-stage clutch guide pin 58c is within the first-rotation guide groove 6d1, the two-stage direct-connection clutch 56 progresses to the carrier 53 and is coupled with the two-stage direct-connection clutch 56, and the carrier 53 is coupled with the sun gear 51 and operates as a single body to ensure a direct-connection transmission. If the two-stage clutch guide pin 58c is within the second-rotation guide groove 6d2, the two-stage transmission clutch 55 progresses to the carrier 53 and is coupled with the two-stage transmission clutch 55 to fix the carrier 53 to the center shaft 5 for transmission.

The ring gear 54 is coupled to the housing 10 as a hub of the transmission not to rotate relatively. Accordingly, if a rotational force of the pinion 52 is transmitted, the housing 10 rotates.

The housing 10 includes a housing which surrounds the epicyclic gear set, is coupled with the ring gear 54 and includes a flange to transmit power to wheels, and a lid 10a which seals the housing to prevent any impurities from being introduced to the housing and to isolate the epicyclic gear set from the outside.

The housing 10 is supported by a bearing 18a fixed to the center shaft 6 by a fixing nut 17a, and the lid 10a is supported by a bearing 8c fixed to the input carrier 13 by a sprocket 9. As a result, the housing 10 and the lid 10a rotate all together.

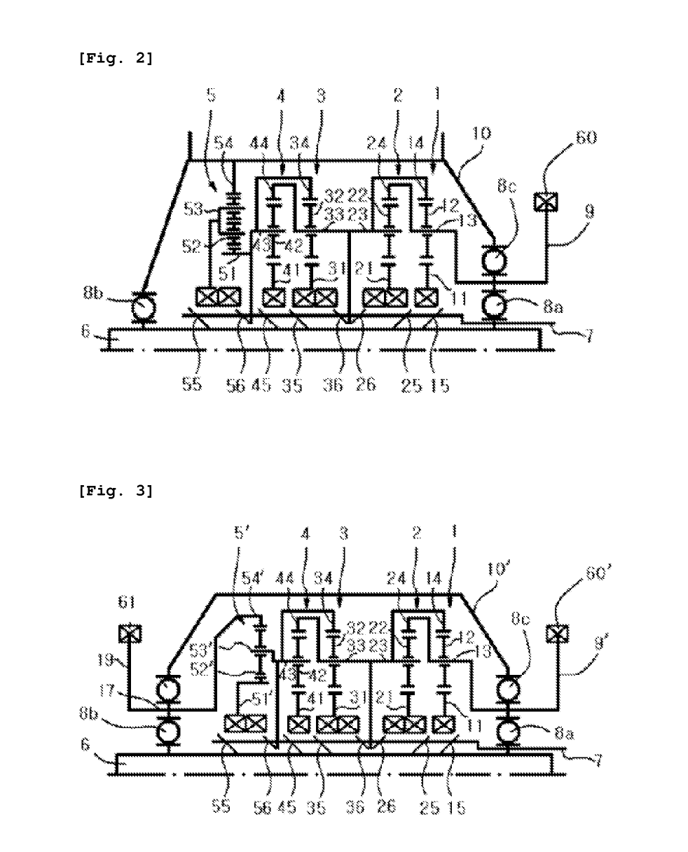

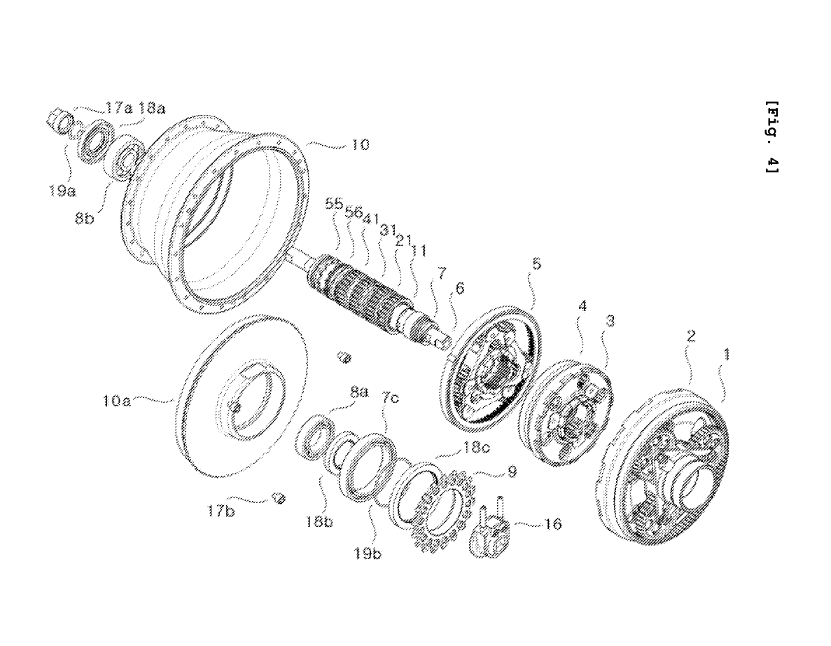

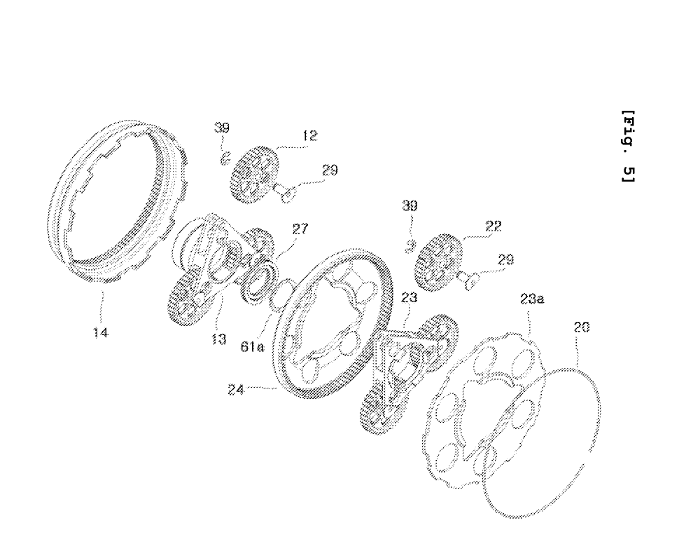

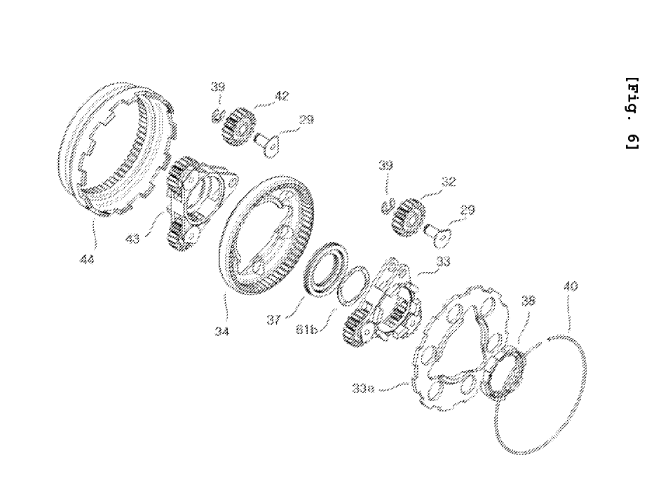

Referring to FIG. 3, a transmission which may be installed in the vicinity of a bicycle crank is shown. A housing 10′ of the transmission is installed closely to the crank and does not rotate with respect to a frame. The rotational force of the crank is transmitted to an input side 9′ of the transmission through a chain or belt 60. A fifth epicyclic gear uses a sun gear 51′ as a fixing element. The sun gear 51′ operates with opposite clutches and uses a single pinion for acceleration and direct-connection transmission. An output side 19 of the transmission transmits power to rear wheels through a sprocket or belt 61.

### First Exemplary Embodiment

Four epicyclic gears were used to form a epicyclic gear set with the gear configuration as in table 1. A transmission shaft has a through hole formed in main surface as in clutches 15, 25, 35 and 45 in table 2, wherein each stage is arranged at an interval of 40° and is open in the width of 50°. As an overlapping part is shared, no problem arises in the operation of pawls. The center shaft has a cam groove formed in an axial direction in a main surface thereof as in clutches 26 and 36 in table 2, wherein each stage is arranged at an interval of 40°. A pair of input epicyclic gears is formed by arranging clutches 15, 25 and 26 in table 2, and a pair of output epicyclic gears is formed by arranging clutches 36, 35 and 45. Increase of transmission at each stage is relatively uniform from 13.3% to 13.8% from 2 stage to 8 stage. At both ends, the transmission increased sharply to 29% and the degree of transmission is 356%.

TABLE 1

| | gear number | number of teeth |
|---|---|---|
| sun gear | 11, 21 | 27 |
| | 31, 41 | 36 |
| epicyclic gear | 12, 22 | 30 |
| | 32, 42 | 21 |
| internal tooth gear | 14, 24 | 93 |
| | 34, 44 | 78 |

TABLE 2

| | | | | | | | input/ | gear |
|---|---|---|---|---|---|---|---|---|
| | | | | | | | output | ratio |
| Transmission | clutch no. (gear ratio) | | | | | | gear | increasing |
| stage | 15 (1.290) | 25 (0.775) | 26 (1.000) | 36 (1.000) | 35 (1.463) | 45 (0.684) | ratio | ratio (%) |
| 1 stage | X | | | X | | | 1.887 | |
| 2 stage | | X | | X | | | 1.463 | 29.1 |
| 3 stage | X | | | | X | | 1.290 | 13.3 |
| 4 stage | | | X | X | | | 1.134 | 13.8 |
| 5 stage | | X | | | X | | 1.000 | 13.4 |
| 6 stage | X | | | | | X | 0.882 | 13.4 |
| 7 stage | | | X | | X | | 0.775 | 13.8 |
| 8 stage | | X | | | | X | 0.684 | 13.4 |
| 9 stage | | | X | | | X | 0.530 | 29.0 |

### Second Exemplary Embodiment

Based on the first exemplary embodiment, a transmission with a uniform degree of transmission has been designed. A 2-stage epicyclic gear has been added to the composition of tables 1 and 2, except for opposite ends with a large degree of transmission, and with the gear composition as in table 3 to thereby form a transmission with 14 stages with two-rotation of a transmission shaft as in table 4.

As one rotation is 7 stages, each stage has been arranged at an interval of 51.4°, and a deceleration ratio of 2-stage clutch has been set as 0.413. Increase in transmission at each stage was relatively uniform from 13.3% to 13.8%, and the degree of transmission was 519% with large transmission area.

TABLE 3

| | gear number | number of teeth |
|---|---|---|
| sun gear | 11, 21, 51 | 27 |
| | 31, 41 | 36 |
| epicyclic gear | 12, 22 | 30 |
| | 32, 42 | 21 |
| | 52a, 52b | 18 |
| internal tooth gear | 14, 24 | 93 |
| | 34, 44 | 78 |
| | 54 | 66 |

TABLE 4

| | | | | | | | | | | Gear |
|---|---|---|---|---|---|---|---|---|---|---|
| | | | | | | | | | Input/ | ratio |
| | | | | | | | | | Output | increasing |
| Transmission | Clutch no. (gear ratio) | | | | | | | | gear | ratio |
| stage | 15 (1.290) | 25 (0.775) | 26 (1.000) | 36 (1.000) | 35 (1.463) | 45 (0.684) | 55 (0.413) | 56 (1.00) | ratio | (%) |
| 1 stage | | X | | X | | | | X | 1.463 | |
| 2 stage | X | | | | X | | | X | 1.290 | 13.3 |
| 3 stage | | | X | X | | | | X | 1.134 | 13.8 |
| 4 stage | | X | | | X | | | X | 1.000 | 13.4 |
| 5 stage | X | | | | | X | | X | 0.882 | 13.4 |
| 6 stage | | | X | | X | | | X | 0.775 | 13.8 |
| 7 stage | | X | | | | X | | X | 0.684 | 13.4 |
| 8 stage | | X | | X | | | X | | 0.604 | 13.3 |
| 9 stage | X | | | | X | | X | | 0.532 | 13.3 |
| 10 stage | | | X | X | | | X | | 0.468 | 13.8 |
| 11 stage | | X | | | X | | X | | 0.413 | 13.4 |
| 12 stage | X | | | | | X | X | | 0.364 | 13.4 |
| 13 stage | | | X | | X | | X | | 0.320 | 13.8 |
| 14 stage | | X | | | | X | X | | 0.282 | 13.4 |

### Third Exemplary Embodiment

To design a transmission which has a finer increase in transmission and large degree of transmission, 18-stage transmission has been designed as in table 7 based on a 9-stage transmission as in tables 5 and 6.

A deceleration ratio of the 2-stage clutch has been set as 0.363 to make the increase in transmission consistent while including the opposite ends in table 6. Except for the opposite sides, the increase in transmission increased relatively uniformly from 11.4% to 12.3%. The degree of transmission was 538% and achieved a large transmission area. If the opposite ends are included, the degree of transmission was 841% and achieved a large transmission area. In the present exemplary embodiment, 9 stage and 10 stage should be changed in order.

TABLE 5

| | | number | |
|---|---|---|---|
| | gear number | of teeth | Remark |
| sun gear | 11, 21 | 24 | |
| | 31, 41 | | |
| | 51 | 30 | Excluded 9 stage |
| epicyclic | 12, 22 | 36 | |
| gear | 32, 42, 52a, 52b | 18 | 52a, 52b excluded |
| | | | from 9 stage |
| internal | 14, 24 | 96 | |
| tooth gear | 34, 44 | 60 | |
| | 54 | 81 | Excluded 9 stage |

TABLE 6

| | | | | | | | | gear |
|---|---|---|---|---|---|---|---|---|
| | | | | | | | input/ | ratio |
| | | | | | | | output | increasing |
| transmission | clutch no. (gear ratio) | | | | | | gear | ratio |
| stage | 15 (1.25) | 25 (0.8) | 26 (1.00) | 36 (1.00) | 35 (1.4) | 45 (0.714) | ratio | (%) |
| 1 stage | X | | | | X | | 1.750 | |
| 2 stage | | | X | | X | | 1.400 | 25.0 |
| 3 stage | X | | | X | | | 1.250 | 12.0 |
| 4 stage | | X | | | X | | 1.120 | 11.6 |
| 5 stage | | | X | X | | | 1.000 | 12.0 |
| 6 stage | X | | | | | X | 0.893 | 12.0 |
| 7 stage | | X | | X | | | 0.800 | 11.6 |
| 8 stage | | | X | | | X | 0.714 | 12.0 |
| 9 stage | | X | | | | X | 0.571 | 25.0 |

TABLE 7

| | | | | | | | | | | gear |
|---|---|---|---|---|---|---|---|---|---|---|
| | | | | | | | | | input/ | ratio |
| | | | | | | | | | output | increasing |
| transmission | clutch no. (gear ratio) | | | | | | | | gear | ratio |
| stage | 15 (1.25) | 25 (0.8) | 26 (1.00) | 36 (1.00) | 35 (1.4) | 45 (0.714) | 55 (0.363) | 56 (1.0) | ratio | (%) |
| 1 stage | X | | | | X | | | X | 1.750 | |
| 2 stage | | | X | | X | | | X | 1.400 | 25.0 |
| 3 stage | X | | | X | | | | X | 1.250 | 12.0 |
| 4 stage | | X | | | X | | | X | 1.120 | 11.6 |
| 5 stage | | | X | X | | | | X | 1.000 | 12.0 |
| 6 stage | X | | | | | X | | X | 0.893 | 12.0 |
| 7 stage | | X | | X | | | | X | 0.800 | 11.6 |
| 8 stage | | | X | | | X | | X | 0.714 | 12.0 |
| 9 stage | X | | | | X | | X | | 0.636 | 12.3 |
| 10 stage | | X | | | | X | | X | 0.571 | 11.4 |
| 11 stage | | | X | | X | | X | | 0.509 | 12.2 |
| 12 stage | X | | | X | | | X | | 0.455 | 11.9 |
| 13 stage | | X | | | X | | X | | 0.407 | 11.8 |
| 14 stage | | | X | X | | | X | | 0.364 | 11.8 |
| 15 stage | X | | | | | X | X | | 0.325 | 12.0 |
| 16 stage | | X | | X | | | X | | 0.291 | 11.7 |
| 17 stage | | | X | | | X | X | | 0.260 | 11.9 |
| 18 stage | | X | | | | X | X | | 0.208 | 25.0 |

1. A multistage transmission comprising:
a center shaft arranged in a frame such that the center shaft does not rotate;
an input member arranged coaxially to the center shaft such that the input member is rotatable;
an epicyclic gear set which is coupled to the input member and which is arranged coaxially to the center shaft such that the epicyclic gear set is rotatable, and which has at least two pairs of epicyclic gears, wherein each of the epicyclic gears has a sun gear, a ring gear, a satellite carrier and a pinion;
an axial clutch which is involved in the operation of the sun gear which is selectively coupled to or separated from at least one of the peripheral members;
a clutch assembly in which at least one of the clutches in a rotating direction are arranged in correspondence with the respective sun gears, wherein said clutches in the rotating direction are involved in the operation of the sun gear which is selectively coupled to or separated from the center shaft;
a transmission shaft which has a hollow portion and a plurality of radial through-holes, and which covers the center shaft and rotates to select a rotating direction, and which is involved in the operation of the clutch assembly; and
a hub arranged coaxially to the center shaft such that the hub is rotatable, and the multistage transmission providing two or more gear ratios between the input member and an output member of the multistage transmission in accordance with the rotating direction of the transmission shaft.

2. The multistage transmission according to claim 1, wherein the epicyclic gear set has an epicyclic gear having a plurality of sun gears are arranged at a distance in an axial direction to be selectively connected to the center shaft with a plurality of concave coupling surfaces, and is supported by the groove of the center shaft, and a plurality of pawls and a plurality of transmission shaft through holes supported by the groove of the center shaft and corresponding to the sun gear are arranged in a space in an axial direction corresponding to the respective sun gears.

3. The multistage transmission according to claim 1, wherein the clutch in an axial direction has the at least one of the sun gear comprising a coupling projection in an axial direction and a peripheral member comprising a coupling projection corresponding to the projection of the sun gear to move in an axial direction in accordance with a rotation direction of the transmission shaft and the center shaft so that the sun gear and the peripheral member are coupled to or separated from each other.

4. The multistage transmission according to claim 3, further comprising a guide groove comprising a cam surface formed in an axial direction in a groove of the center shaft in a circumferential direction;
a guide pin which rotates along a through hole formed in an axial direction of the transmission shaft and moves in an axial direction along the cam surface;
a guide ring which surrounds the transmission shaft, accommodates the guide pine, moves along the guide pin, and supports the sun gear or the peripheral member in a direction in which the clutch is separated; and
a spring which presses the clutch in a coupling direction to thereby move the sun gear or the peripheral member in an axial direction.

5. The multistage transmission according to claim 4, wherein at least two clutches in the axial direction are provided.

6. The multistage transmission according to claim 4, wherein the cam surface formed in the axial direction corresponds to the guide pin and rotates the transmission shaft and is arranged in accordance with a predetermined program in a circumference of the center shaft in a manner in which all of gear ratios which may be selected by the assistance of the guide ring with the rotation of the transmission shaft are selected in a consecutive order that may be selected in advance.

7. The multistage transmission according to claim 1, wherein the clutch in the rotational direction comprises a plurality of coupling surfaces which is formed in an internal circumference where the sun gear contacts the transmission shaft, a pawl which is supported by the center shaft and is selectively coupled to or separated from the coupling surfaces, and a plurality of through holes in a radial direction which is involved in the control of the pawl.

8. The multistage transmission according to claim 7, wherein the center shaft comprises at least one a guide slit which extends in a circumferential direction and accommodates the pawl and a pawl support groove which is formed across the center shaft so that the pawl is located within the guide slit and is mounted to rotate centering on the pawl support groove and the pawl is coupled to a coupling surface of the sun gear when the through hole of the transmission shaft is open.

9. The multistage transmission according to claim 1, further comprising a bidirectional member which comprises a coupling projection in opposite directions to be coupled with either the center shaft and the peripheral member;
a 2-stage transmission clutch which comprises a coupling projection facing a projection of the bidirectional member and is coupled to the center shaft not to rotate and moves in an axial direction; and
a 2-stage direct-connection clutch which comprises a coupling projection facing a projection of the bidirectional member and moves in an axial direction, wherein the 2-stage transmission clutch and the 2-stage direct-connection clutch move in an axial direction in accordance with a rotation direction formed by the transmission shaft and the center shaft so that the bidirectional member is coupled with one of the 2-stage transmission clutch and the 2-stage direct-connection clutch.

10. The multistage transmission according to claim 9, wherein the 2-stage clutch comprises a guide groove which comprises a groove formed in the center shaft by two rotations in a circumferential direction, a guide pin which rotates along a through hole formed in an axial direction of the transmission shaft and moves in an axial direction along the guide groove, a guide ring which maintains a gap between the 2-stage transmission clutch and the 2-stage direct-connection clutch, surrounds the transmission shaft, accommodates the guide pin and moves along the guide pin, and two springs which presses in a direction in which the 2-stage transmission clutch and the 2-stage direct-connection clutch are coupled with the bidirectional member to move the 2-stage transmission clutch and the 2-stage direct-connection clutch so that the bidirectional member is coupled to the 2-stage direct-connection clutch in a one-rotation guide groove of the transmission shaft, and the bidirectional member is coupled to the 2-stage transmission clutch in a two-rotation guide groove of the transmission shaft.

11. The multistage transmission according to claim 9, wherein the bidirectional member comprises one of the sun gear and the satellite carrier.

12. The multistage transmission according to claim 3, wherein the coupling projection comprises one side that is inclined tooth arrangement, receives compressive stress by a spring in an axial direction and is coupled to a rotation in one direction for rotation, and a tooth arrangement that is separated from an inclined tooth by a rotation in an opposite direction.

13. The multistage transmission according to claim 1, wherein the multistage transmission comprises a 9-stage transmission wherein a gear ratio of 9 stages may be selected by one rotation of the transmission shaft.

14. The multistage transmission according to claim 13, wherein the 9-stage transmission comprises four pairs of epicyclic gears, two clutches in an axial direction and four clutches in a rotation direction.

15. The multistage transmission according to claim 1, wherein the multistage transmission comprises an 18-stage transmission, and a gear ratio of 18 stages may be selected by a two-rotation guide groove of the center shaft and two rotations of the transmission shaft.

16. The multistage transmission according to claim 15, wherein the 18-stage transmission comprises five pairs of epicyclic gears, two clutches in an axial direction, four clutches in a rotation direction, and one 2-stage clutch.

17. The multistage transmission according to claim 2, wherein the center shaft comprises a pawl support groove which is formed in an axial direction to support and rotate the pawl, a guide slit which is formed to accommodate the pawl in the center shaft, a spring groove which accommodates a spring giving compressive stress so that the pawl stands toward a coupling surface of the sun gear and a guide groove comprising a cam surface in an axial direction in a groove formed in a circumferential direction.

18. The multistage transmission according to claim 17, wherein the center shaft further comprises a two-rotation guide groove formed by two rotations in a circumferential direction.

19. The multistage transmission according to claim 17, wherein the center shaft comprises a through hole in an axial direction to accommodate a rotational shaft and supports the rotational shaft and the input member to rotate.

20. The multistage transmission according to claim 1, wherein the transmission shaft has a through hole that is formed in a main surface and arranged to correspond to the pawl and is arranged in a predetermined program in a circumference of the transmission shaft in a manner in which all of gear ratios which may be selected by the rotation of the transmission shaft and by fixing the sun gear by the contact of the pawl and the through are selected in a consecutive order that may be selected in advance.

21. The multistage transmission according to claim 2, wherein the transmission shaft has a pawl through hole which permits a rotation in a direction in which the pawl is coupled with the sun gear and a direct-connection clutch guide pin guide groove which is formed in an axial direction to guide a direct-connection clutch guide pin operating the clutch in an axial direction.

22. The multistage transmission according to claim 21, wherein a part of a lateral wall of the pawl through hole in a rotation direction is designed to remove, i.e., separate the pawl from the coupling surface of the sun gear.

23. The multistage transmission according to claim 21, wherein a two-rotation guide pin through hole is further formed in a main surface to guide the two-rotation guide pine operating the 2-stage clutch.

24. The multistage transmission according to claim 2, wherein the sun gear is shaped like a ring, is mounted in the transmission shaft to rotate and has a plurality of concave coupling surfaced formed in an internal circumference to be coupled with the pawl and safely secures a separation of the racket from the coupling surface within the range of the pawl.

25. The multistage transmission according to claim 24, wherein the sun gear further comprises a coupling projection in an axial direction which comprises one side that is inclined tooth arrangement, receives compressive stress by a spring in an axial direction and is coupled to a rotation in one direction for rotation, and a tooth arrangement that is separated from an inclined tooth by a rotation in an opposite direction.

26. The multistage transmission according to claim 7, wherein a projection is formed in both shoulders of the pawl to support the pawl and prevents the pawl from being separated from its position, and a spring groove is formed to accommodate a spring giving compressive stress so that the pawl stands toward a coupling surface of the sun gear.

27. The multistage transmission according to claim 7, wherein the pawl further comprises an accommodation cam surface which guides the pawl to be accommodated in the guide slit by a lateral wall of a through hole of the transmission shaft rotating toward a pawl coupling surface coupled to a coupling surface of the sun gear.

28. The multistage transmission according to claim 27, wherein the accommodation cam surface of the pawl is a convex surface in which a lowest point of the cam surface does not go past the internal surface of the transmission shaft when the pawl stands fully, and an angle formed between the lateral wall of the transmission shaft and a normal of the transmission shaft is 45° or more.

29. The multistage transmission according to claim 7, wherein a spring member is provided to give compressive stress so that the pawl rotates in a direction in which the pawl is coupled with the coupling surface of the sun gear.
